(19) United States
(12) Patent Application Publication
(10) Pub. No.: US 2026/0237889 A1
(43) Pub. Date: Aug. 13, 2026

(54) SINGLE ANCHOR ULTRA-WIDEBAND ANTENNA ARRAY

(71) Applicant: Qorvo US, Inc., Greensboro, NC (US)

(72) Inventors: Abdallah Dhouibi, Toulouse (FR); Julien Schrive, Toulouse (FR); Matthias John, Newtownmountkennedy (IE)

(21) Appl. No.: 19/359,039

(22) Filed: Oct. 15, 2025

Related U.S. Application Data
(60) Provisional application No. 63/755,495, filed on Feb. 7, 2025.

(51) Int. Cl. H01Q 1/32; B60R 25/24; H01Q 5/25; H01Q 9/16

(52) U.S. Cl. CPC H01Q 1/3241; B60R 25/245; H01Q 5/25; H01Q 9/16; B60R 2325/10

(57) ABSTRACT

A vehicle includes an ultrawideband (UWB) anchor disposed within the vehicle. The anchor includes three antenna elements. A method for localizing a peer UWB device relative to the vehicle includes, with the three antenna elements, receiving a UWB signal from the peer UWB device. The method also includes computing a phase difference of arrival (PDoA) value of the UWB signal for each pair of the three antenna elements, yielding three PDoA values. The method also includes translating at least two of the PDoA values into an angle of arrival (AoA) value, and, based on the AoA value and a distance from the anchor to the peer UWB device, determining a position of the peer UWB device relative to the anchor.

### CROSS REFERENCE TO RELATED APPLICATIONS

This application claims the priority benefit under 35 U.S.C. § 119(e) of U.S. Provisional Patent Application No. 63/755,495 filed 7 Feb. 2025 for Qorvo US, Inc., hereby incorporated by reference in its entirety as though fully set forth herein.

### TECHNICAL FIELD

The present disclosure relates generally to systems, devices, and methods relating to a single anchor ultra-wideband antenna array for keyless vehicle access. This single-anchor UWB antenna array has particular but not exclusive utility for automotive keyless entry systems.

### BACKGROUND

The current technology for keyless car access systems typically relies on multiple anchors, often up to six, to accurately determine the position of the key fob relative to the vehicle. These anchors work together to triangulate the key's location, ensuring that the vehicle only unlocks when the key is within a specific range. While effective, this multi-anchor setup can be complex, costly, and space-consuming, requiring extensive hardware integration and calibration.

The use of multiple anchors may present several technical challenges. The complexity of installation and maintenance increases with the number of anchors, leading to higher costs and potential points of failure. Additionally, the need for multiple anchors can limit design flexibility and increase the vehicle's weight. These issues may necessitate a more streamlined technique that can maintain or improve the accuracy and reliability of keyless entry systems while reducing the hardware footprint and associated costs.

Thus, there remains a need for effective ways to create a single anchor ultra-wideband antenna array for keyless vehicle access.

The information included in this Background section of the specification, including any references cited herein and any description or discussion thereof, is included for technical reference purposes only and is not to be regarded as subject matter by which the scope of the disclosure is to be bound.

### SUMMARY

Embodiments of the present disclosure include systems, devices, and methods of creating a single-anchor ultrawideband (UWB) antenna array for keyless vehicle access. The single-anchor UWB antenna array may for example be integrated into the vehicle's shark fin antenna, and may reduce or eliminate the need for the vehicle to include multiple anchors. This approach simplifies the hardware setup, reducing complexity and potential points of failure associated with multi-anchor systems. By employing innovative ranging techniques coupled with phase difference of arrival (PDoA) calculations, the system achieves precise key fob positioning, ensuring secure and reliable vehicle access.

The single-anchor UWB antenna array disclosed herein has particular, but not exclusive, utility for controlling smart door locks in buildings and vehicles. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for localizing a peer ultrawideband (UWB) device relative to a vehicle. The method includes with three antenna elements of an anchor disposed within a vehicle, receiving a UWB signal from the peer UWB device; computing a phase difference of arrival (PDoA) value of the UWB signal for each pair of the three antenna elements, yielding three PDoA values. The method also includes translating at least two PDoA values of the three PDoA values into an angle of arrival (AoA) value. The method also includes, based on the AoA value and a distance from the anchor to the peer UWB device, determining a position of the peer UWB device relative to the anchor. Other embodiments of this aspect include corresponding computer systems, apparatus, and computer programs recorded on one or more computer storage devices, each configured to perform the actions of the methods.

Implementations may include one or more of the following features. The method may include computing the distance from the anchor to the peer UWB device based on two-way ranging between the anchor and the peer UWB device. The three antenna elements may be coplanar and arranged in an isosceles triangle. Each of the three antenna elements may be an omnidirectional antenna element. Each antenna element of the three coplanar antenna elements may include: a planar dielectric substrate; a first crossed dipole antenna printed on a first side of the planar dielectric substrate; and a second crossed dipole antenna printed on a second side the planar dielectric substrate. The anchor further may include: two multiplexers; and two receivers configured to receive second UWB signals from the peer device via the three antenna elements and the two multiplexers. A position error of the anchor in measuring the position of the peer UWB device may be between 0 centimeters and 10 centimeters at a range of 3 meters and between 0 centimeters and 15 centimeters at a range of 5 meters. Implementations of the described techniques may include hardware, a method or process, or computer software on a computer-accessible medium.

One general aspect includes an ultrawideband (UWB) system for localizing a peer UWB device relative to a vehicle. The UWB system includes am anchor disposed within the vehicle, the anchor may include three antenna elements configured to receive a UWB signal from the peer UWB device. The system also includes a processor configured to: compute a phase difference of arrival (PDoA) value of the UWB signal for each pair of the three antenna elements, yielding three PDoA values; translate at least two of the PDoA values into an angle of arrival (AoA) value; and based on the AoA value and a distance from the anchor to the peer UWB device, determine a position of the peer UWB device relative to the anchor. Other embodiments of this aspect include corresponding computer systems, apparatus, and computer programs recorded on one or more computer storage devices, each configured to perform the actions of the methods.

Implementations may include one or more of the following features. In some embodiments, the processor may be further configured to use UWB two-way ranging between the anchor and the UWB peer device to compute the distance from the anchor to the peer UWB device. The three antenna elements may be coplanar and arranged in an isosceles triangle. Each of the three antenna elements may be an omnidirectional antenna element. Each antenna element of the three coplanar antenna elements may include: a planar dielectric substrate; a first crossed dipole antenna printed on a first side of the planar dielectric substrate; and a second crossed dipole antenna printed on a second side the planar dielectric substrate. The anchor further may include: two multiplexers; and two receivers configured to receive second UWB signals from the peer device via the three antenna elements and the two multiplexers. A position error of the anchor in measuring the position of the peer UWB device may be between 0 centimeters and 10 centimeters at a range of 3 meters and between 0 centimeters and 15 centimeters at a range of 5 meters. Implementations of the described techniques may include hardware, a method or process, or computer software on a computer-accessible medium.

One general aspect includes a vehicle. The vehicle includes an ultrawideband (UWB) system for localizing a peer UWB device relative to the vehicle, the UWB system including: an anchor disposed within the vehicle, the anchor including three antenna elements configured to receive a UWB signal from the peer UWB device; and a processor. The procressor is configured to: compute a phase difference of arrival (PDoA) value of the UWB signal for each pair of the three antenna elements, yielding three PDoA values; translate at least two of the PDoA values of the three PDoA values into an angle of arrival (AoA) value; and based on the AoA value and a distance from the anchor to the peer UWB device, determine a position of the peer UWB device relative to the anchor. Other embodiments of this aspect include corresponding computer systems, apparatus, and computer programs recorded on one or more computer storage devices, each configured to perform the actions of the methods.

Implementations may include one or more of the following features. In some embodiments, the processor is further configured to use UWB two-way ranging between the anchor and the UWB peer device to compute the distance from the anchor to the peer UWB device. The three antenna elements may be coplanar and arranged in an isosceles triangle. Each of the three antenna elements may be an omnidirectional antenna element. Each antenna element of the three coplanar antenna elements may include: a planar dielectric substrate; a first crossed dipole antenna printed on a first side of the planar dielectric substrate; and a second crossed dipole antenna printed on a second side the planar dielectric substrate. The anchor further may include: two multiplexers; and two receivers configured to receive second UWB signals from the peer device via the three antenna elements and the two multiplexers. Implementations of the described techniques may include hardware, a method or process, or computer software on a computer-accessible medium.

Additional aspects, features, and advantages of the present disclosure will become apparent from the following detailed description. This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the single-anchor UWB antenna array, as defined in the claims, is provided in the following written description of various embodiments of the disclosure and illustrated in the accompanying drawings.

### BRIEF DESCRIPTION OF THE DRAWINGS

The accompanying drawing figures incorporated in and forming a part of this specification illustrate several aspects of the disclosure, and together with the description, serve to explain the principles of the disclosure.

FIG. 1 is top side perspective view of an example single-anchor three element antenna array, in accordance with at least one embodiment of the present disclosure.

FIG. 2A is a top view of the example antenna array of FIG. 1, in accordance with at least one embodiment of the present disclosure.

FIG. 2B is a side view of the example antenna array of FIG. 1, in accordance with at least one embodiment of the present disclosure.

FIG. 3 is a bottom view of the example antenna array of FIG. 1, in accordance with at least one embodiment of the present disclosure.

FIG. 4A is a polar plot of Time of Flight (TOF) based distance measurement as a function of angle, in accordance with at least one embodiment of the present disclosure.

FIG. 4B is a polar plot of position measurement error as a function of angle at two different measurement distances, in accordance with at least one embodiment of the present disclosure.

FIG. 5 is a plot of lookup table (LUT) curves showing phase difference of arrival (PDoA) as a function of angle, for the three different antenna element pairs, in accordance with at least one embodiment of the present disclosure.

FIG. 6 is a plot of the standard deviation of the PDOA LUT curves in FIG. 5 as a function of angle, for the three antenna element pairs, in accordance with at least one embodiment of the present disclosure.

FIG. 7 is a schematic, diagrammatic representation, in flow diagram form, of an example angle of arrival (AoA) calculation method, in accordance with at least one embodiment of the present disclosure.

FIG. 8 illustrates a device localization system 800, in accordance with at least one embodiment of the present disclosure.

FIG. 9 is a plot showing the mean angle of arrival (AoA) error as a function of angle, in accordance with at least one embodiment of the present disclosure.

FIG. 10 is a plot showing link budget or received signal power level (e.g., in dB) as a function of angle (e.g., in degrees), at an antenna located 5 meters from the signal source, for each of two receivers and, in accordance with at least one embodiment of the present disclosure.

FIG. 11 is a schematic, diagrammatic representation of a wireless device incorporating the single-anchor UWB antenna array, in accordance with at least one embodiment of the present disclosure.

FIG. 12 is a schematic, diagrammatic representation, in flow diagram form, of an example method for localizing a peer UWB device relative to a vehicle, in accordance with at least one embodiment of the present disclosure.

FIG. 13 is a schematic diagram of a wireless communication device, in accordance with at least one embodiment of the present disclosure.

### DETAILED DESCRIPTION

Disclosed herein are systems, devices, and methods which may offer significant technical benefits by utilizing a single anchor ultra-wideband (UWB) antenna array attached to a vehicle, such as integrated into the vehicle's shark fin antenna. This approach simplifies the hardware setup, reducing complexity and potential points of failure associated with multi-anchor systems. By employing innovative ranging techniques coupled with phase difference of arrival (PDoA) calculations, the system achieves precise key fob positioning, ensuring secure and reliable vehicle access.

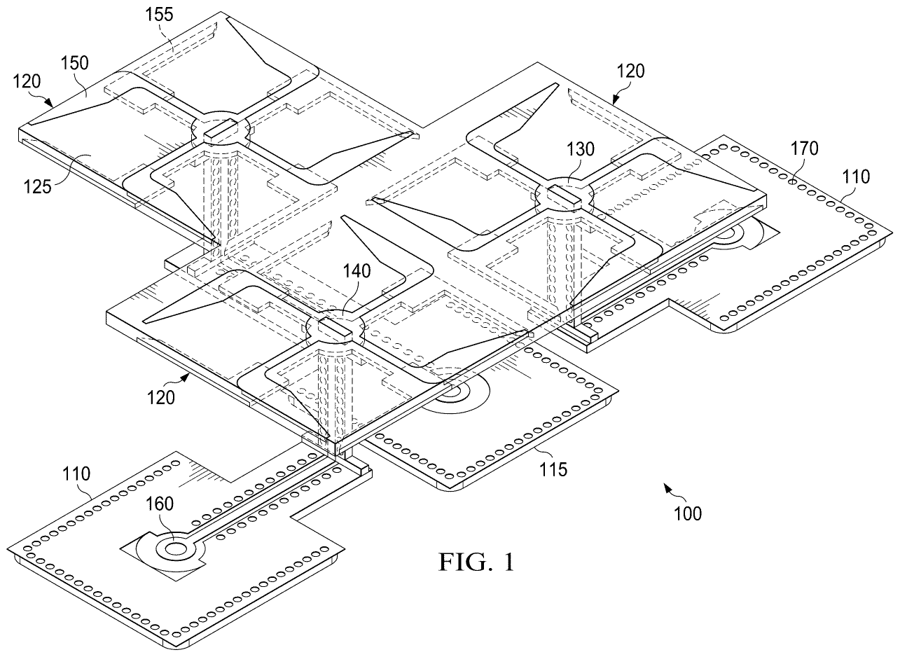

The antenna design aims to innovate in the field of automotive access systems by transitioning from a multi-anchor setup (6 anchors in different placements of the car) to a sophisticated single-anchor system based on a 3 elements antenna array as shown in FIG. 1 utilizing Phase Difference of Arrival with Ultra-Wideband (UWB) technology.

These descriptions are provided for exemplary purposes only, and should not be considered to limit the scope of the single-anchor UWB antenna array. Certain features may be added, removed, or modified without departing from the spirit of the claimed subject matter.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

FIG. 1 is top side perspective view of an example single-anchor three element antenna array 100, in accordance with at least one embodiment of the present disclosure. The antenna array 100 is designed with three omnidirectional elements 120, each consisting of four crossed dipole antennas 150, 155 printed on both sides of a dielectric substrate 125. This configuration creates an electric field parallel to the substrate plane, resulting in a toroidal radiation pattern that is also parallel to the substrate. To interface the antenna with a development board which has three RF ports, a microstrip line 140 electrically coupled to a conductive hubs 130 of the crossed dipole antennas 150, 155 is employed. This line connects each antenna element 120 to its own SubMiniature Version A (SMA) board 110 or 115, equipped with an SMA connector 160, facilitating seamless integration and connectivity.

In the example shown in FIG. 1, the antenna array 100 includes a first crossed dipole antenna 150 printed on the top surface of each dielectric substrate 125 and a second crossed dipole antenna 155 printed on the bottom surface of each dielectric substrate 125. Also visible are conductive vias or through-holes 170 in the SMA boards 110.

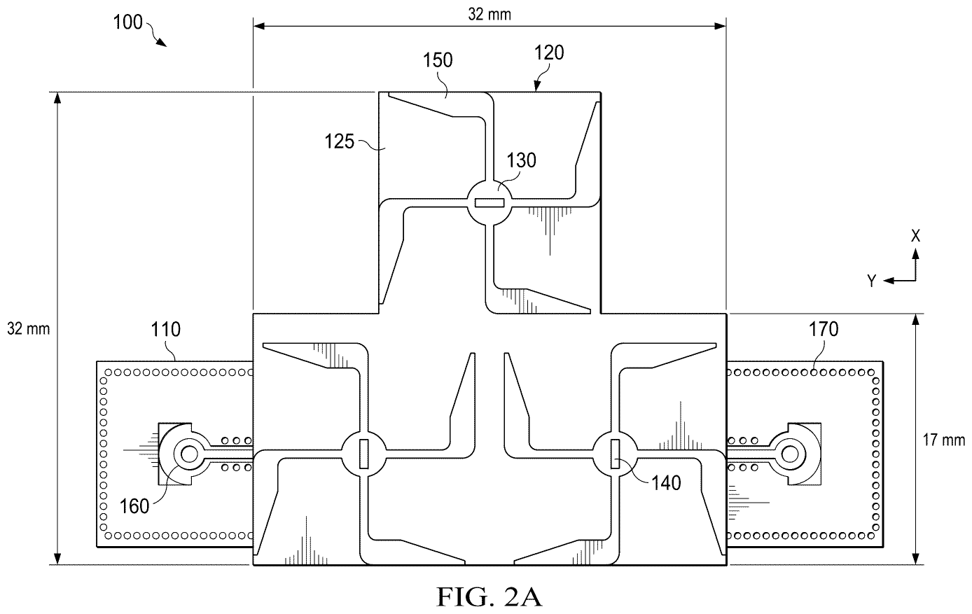

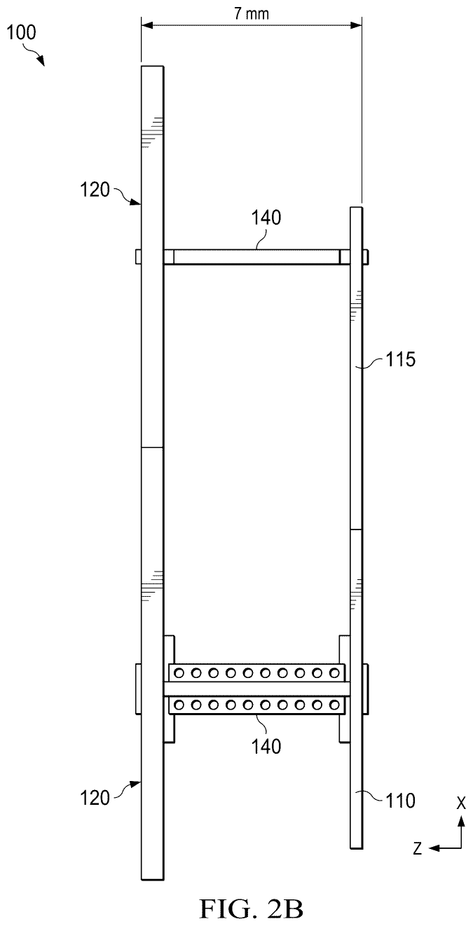

FIG. 2A is a top view of the example antenna array 100 of FIG. 1, in accordance with at least one embodiment of the present disclosure. Visible are the antenna elements 120, including substrates 125 with crossed dipole antennas 150 printed on their top surfaces. Also visible are the hubs 130 connecting to the microstrip lines 140, as well as the SMA boards 110 with SMA connectors 160 and conductive vias 170.

The antenna system includes three antenna elements 120 arranged in a triangle and with each pair spaced by ~0.45λ at the center frequency of the highest channel of operation (17 mm in this example for UWB channel 9), with a 1 mm gap between the crossed dipoles 150, such that each pair of elements 120 is 32 mm wide. A person of ordinary skill in the art will appreciate that for different operating frequencies, different dimensions may be used, and also that the exact dimensions of the antenna array 100 may be slightly larger or smaller (e.g., 1-2 mm larger or smaller) than optimal for a given wavelength, in order to account for manufacturing convenience and/or the dimensions of the portion of the vehicle meant to receive the antenna (e.g., the shark fin housing on the vehicle roof).

FIG. 2B is a side view of the example antenna array 100 of FIG. 1, in accordance with at least one embodiment of the present disclosure. Visible are the SMA boards 110 and 115, antenna elements 120, and microstrip lines 140.

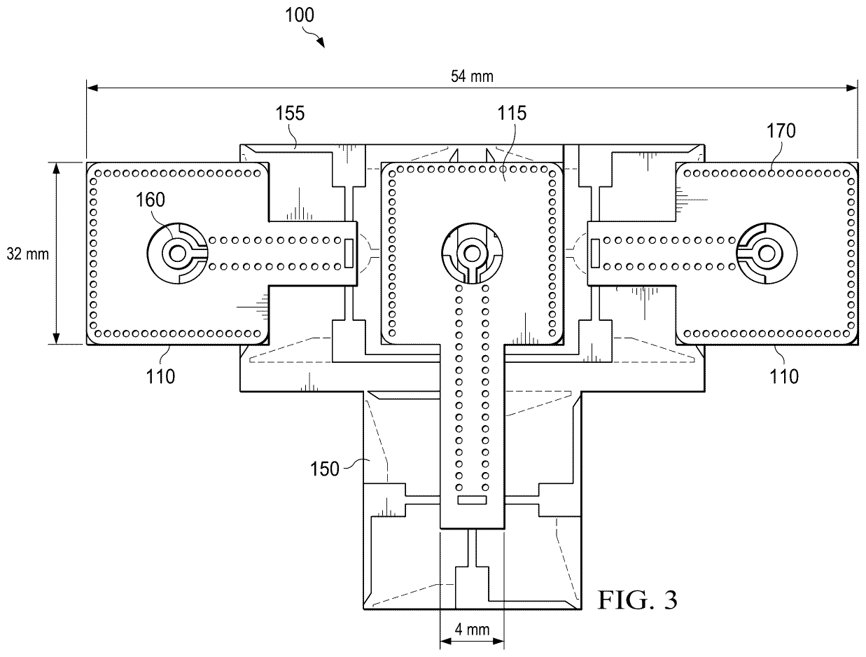

FIG. 3 is a bottom view of the example antenna array 100 of FIG. 1, in accordance with at least one embodiment of the present disclosure. Visible are the crossed dipoles 150 and 155, as well as two short, key-shaped SMA boards 110 and one long, key-shaped SMA board 115, each including an SMA connector 160 and conductive vias 170.

Some examples of the objectives of the antenna design illustrated in FIGS. 1-3 is to:

Reduce System Complexity: Transition from the existing 6-anchor system to a single-anchor configuration, while ensuring that functionality and reliability are maintained or even enhanced. The antenna array 100 may for example be capable of providing full 360° coverage around the car.

Enhance Precision and Reliability: Employ Phase Difference of Arrival (PDOA) and beamforming techniques to accurately determine the position and approach to a vehicle, thereby improving the overall performance of the keyless access system.

The antenna design illustrated in FIGS. 1-3 has been tested based on the following key performance metrics:

### Ranging Accuracy

Evaluate the accuracy of ranging measurements around a car equipped with the antenna array 100, particularly within a 5-meter radius.

Assess the consistency of ranging results to ensure reliable keyless access.

### Phase Difference of Arrival (PDOA) Performance

Measure PDOA accuracy around the vehicle to determine its effectiveness in position detection.

Evaluate the translation of Angle of Arrival (AoA) to PDOA using simple Look-Up Tables (LUTs).

Analyze the standard deviation of PDOA measurements to assess the precision and stability of the system.

### Power Levels and Link Budget

Determine the power levels required to maintain a good link budget.

During testing, the antenna array 100 was installed at the shark antenna position on the vehicle, representing an exemplary operational location. The testing of the antenna was conducted by moving a UWB peer device (e.g., a key fob) around the vehicle at a consistent distance of 1 meter, with measurements taken in 5-degree increments to ensure comprehensive coverage. This approach can facilitate a thorough evaluation of the antenna's performance in terms of ranging accuracy and PDOA measurement. The test took place in a garage environment, with the UWB peer device on a tripod and moving around the car. Although this method may introduce some variability due to the lack of precision, the results have demonstrated reliability, providing meaningful insights into the system's capabilities.

A software program with a Graphical User Interface was implemented on the test transceiver, which is specifically designed to handle ultra-wideband (UWB) communications. The software retrieves three phase difference arrival (PDOA) values, which are then transformed into an angle of arrival (AoA) measurement. This processing, which involves complex mathematical transformations and signal analysis, enhances the system's ability to accurately determine the key fob's position.

### Measurement Results

### Ranging Performance

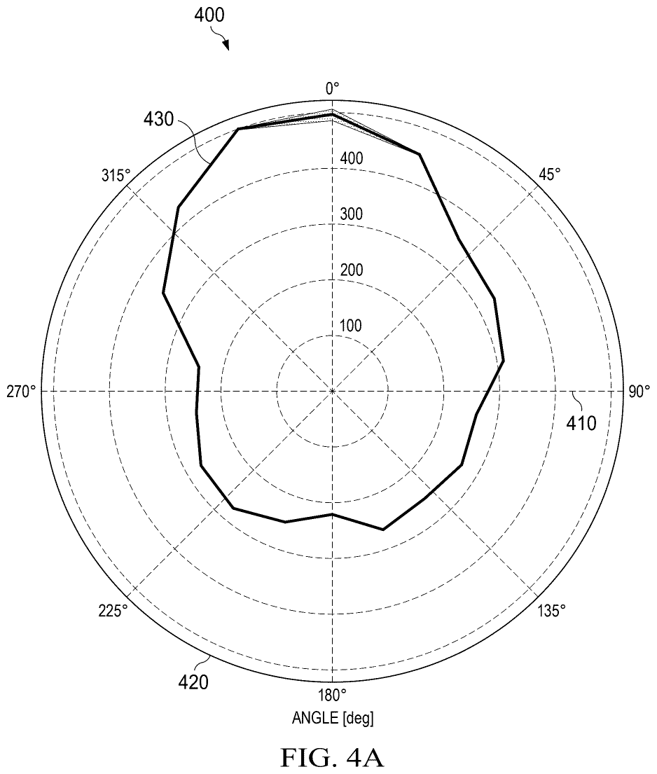

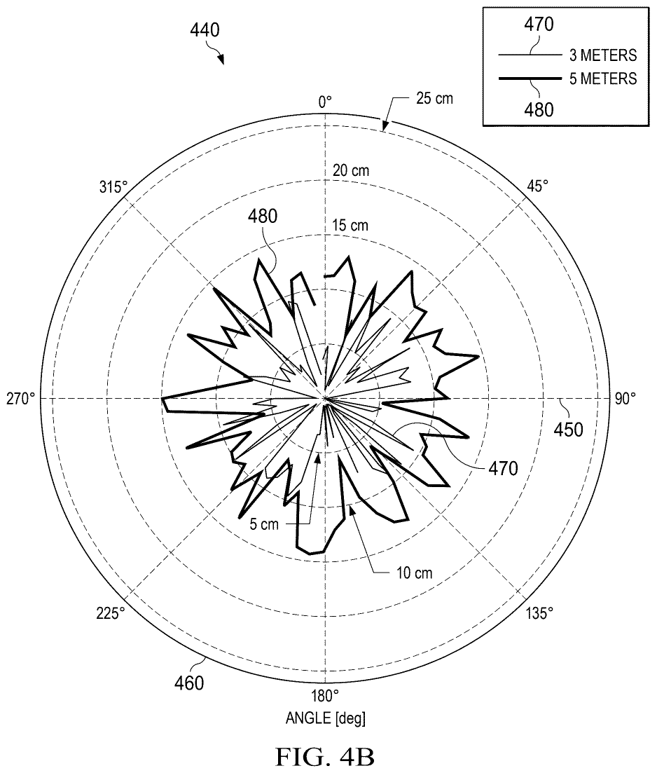

FIG. 4A is a polar plot 400 of a Time of Flight (TOF) based distance measurement 410 as a function of angle 420, in accordance with at least one embodiment of the present disclosure. The plot 400 is constructed with angles ranging from 0 to 360 degrees in 5-degree increments, providing a comprehensive view of the performance test pattern around the car. The radial axis represents the distance measurement 410, with values ranging from 220 to 500 centimeters. The measurement line 430 shows that for each tested position, the distance measurements remain stable and consistent. The disclosed system provides full coverage around the car without any blind zones.

FIG. 4B is a polar plot 440 of position measurement error 450 as a function of angle 460 at two different measurement distances: 3 meters, and 5 meters, in accordance with at least one embodiment of the present disclosure. The plot 440 is constructed with angles 460 ranging from 0 to 360 degrees in 5-degree increments, providing a comprehensive view of the error pattern around the car. The radial axis 450 represents the range error in centimeters, with values ranging from 5 cm to 10 cm.

The 3-meter range line 470 shows a position error of between 0 cm and 10 cm, depending on the angle. Similarly, the 5-meter range line 480 shows a position error of between 5 cm and 15 cm, depending on the angle. The plot 440 shows that the position error appears randomly distributed within the specified limits for each distance. The errors remain within a consistent range, indicating reliable performance of the antenna system. The error patterns do not exhibit significant directional bias, suggesting that the antenna maintains uniform accuracy across different angles. Position errors of up to 10 cm at a range of 3 meters, and up to 15 cm at a range of 5 meters, may be acceptable for keyless entry applications for vehicle and building doors.

### PDOA Performance

### LUT Measurements

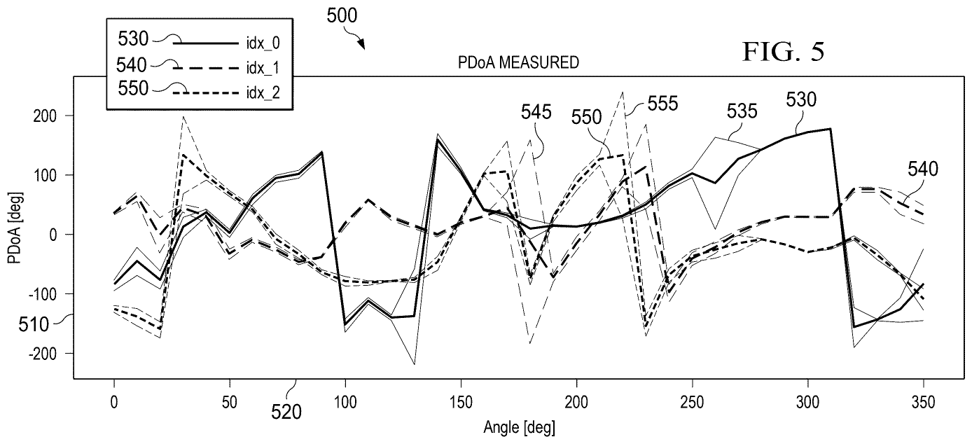

FIG. 5 is a plot 500 of lookup table (LUT) curves 530, 540, 550, showing phase difference of arrival (PDoA) as a function of angle, for the three different antenna element pairs, in accordance with at least one embodiment of the present disclosure. Each curve corresponds to a different measurement antenna pair, showcasing how the PDOA changes with the vehicle's orientation. To address potential wrapping issues inherent in phase measurements, the PDOA curves have been post-processed using the circular mean. This ensures the PDOA values are represented smoothly and continuously, without discontinuities. The plot 500 also includes the standard deviation 535, 545, 555 of each PDOA curve 530, 540, 550, highlighting the consistency and variability of the measurements. The trends exhibit a smooth and predictable pattern as the vehicle turns, indicating a stable and reliable measurement process at least for two antenna pair from the available 3 antenna pairs at any given angle. The relatively low standard deviation across the curves suggests that the PDOA measurements are consistent and repeatable. These exemplary LUT curves 530, 540, 550 may be stored in a LUT table and used to calculate the angle of arrival (AoA).

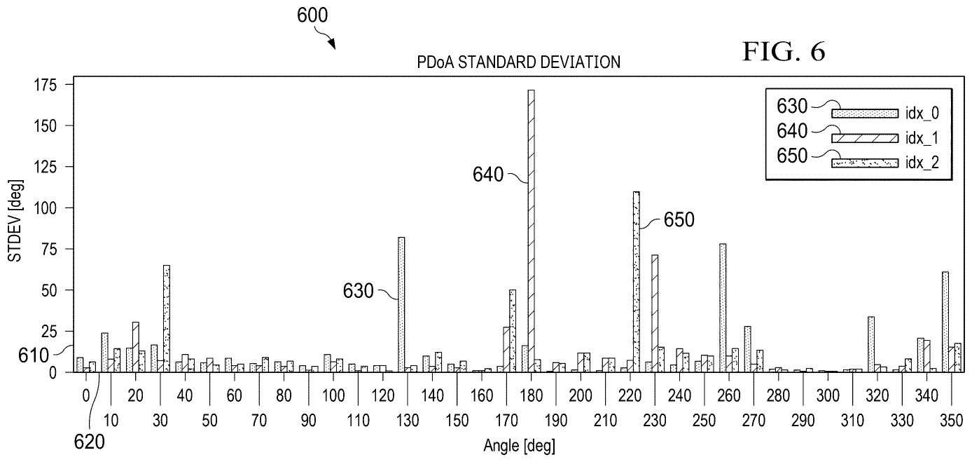

FIG. 6 is a plot 600 of the standard deviation 610 of the PDOA LUT curves in FIG. 5 as a function of angle 620, for the three antenna element pairs 630, 640, 650, in accordance with at least one embodiment of the present disclosure. As can be seen in the plot 600, there are some angles 620 where one of the standard deviations hits a large peak, of 60 degrees or more, indicating a large error in the measurement of PDoA for that antenna pair at that angle, possibly caused by signal blockage from vehicle components. However, in each of these cases, the standard deviation 610 for the other two antenna pairs is below 25 degrees, thus demonstrating that two reliable PDoA measurements are available at each angle 620. Indeed, for the majority of angles 620, the PDoA standard deviation is under 10 degrees for all three antenna pairs 630, 640, 650.

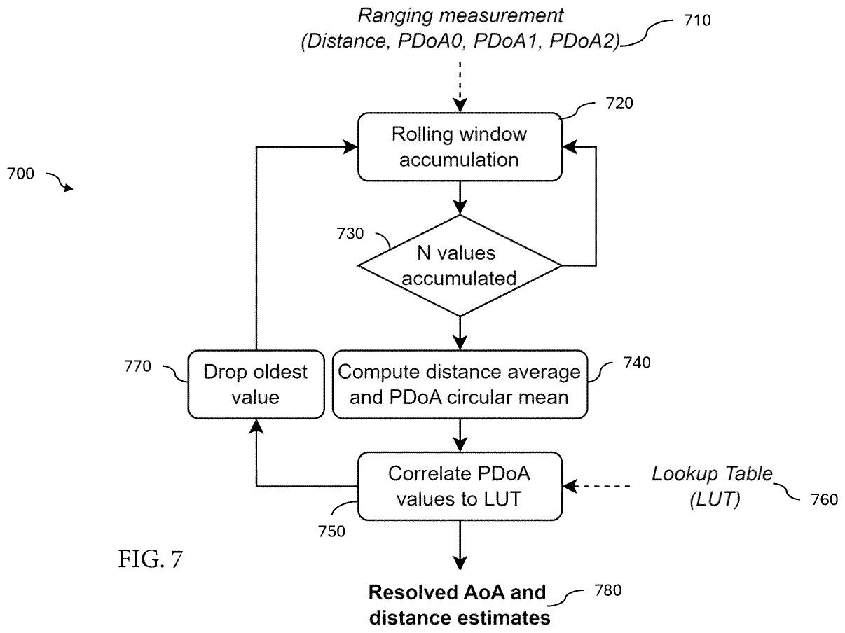

FIG. 7 is a schematic, diagrammatic representation, in flow diagram form, of an example angle of arrival (AoA) calculation method 700, in accordance with at least one embodiment of the present disclosure. The Angle of Arrival (AoA) is retrieved from the three PDOA curves of a Look-Up Table (LUT). It is understood that the steps of method 700 may be performed in a different order than shown in FIG. 7, additional steps can be provided before, during, and after the steps, and/or some of the steps described can be replaced or eliminated in other embodiments. One or more of steps of the method 700 can be carried by one or more devices and/or systems described herein, such as components of the wireless device 1100 and/or processor circuit 1350.

In step 720, the method 700 includes receiving a ranging measurement 710 from a UWB wireless device. The ranging measurement includes a distance from the antenna array to the peer device (e.g., a key fob), as well as a PDoA value for each of the three antenna pairs. In step 720, the method 700 also includes performing a rolling window accumulation of the measured parameters (range, PDoA0, PDoA1, PDoA2). This accumulation can be used to improve the system robustness to measurement noise, and permits the circular averaging in step 740, below. Execution then proceeds to step 730.

In step 730, the method 700 includes determining whether N values of the measured parameters have been accumulated, where N is a positive integer (such as 1, 2, 3, etc.) indicating the size of the rolling window. If no, execution returns to step 720. If yes, execution proceeds to step 740.

In step 740, the method includes calculating, from the N values, an average value of the distance and a circular mean of each PDoA. Execution then proceeds to step 750.

In step 750, the method 700 includes correlating the PDoA values to a lookup table 760 in order to determine the AoA. In an example, the PDoA values are used as an index to the lookup table entries. The table entry that is closest to the measured PDoA is used to select the corresponding AoA. Step 750 then generates an output 780 that includes the distance average and the AoA. Execution then proceeds to step 770.

In step 770, the method 700 includes dropping the oldest value from the rolling window. Execution then returns to step 720.

Flow diagrams are provided herein for exemplary purposes; a person of ordinary skill in the art will recognize myriad variations that nonetheless fall within the scope of the present disclosure. For example, any of the steps described herein may optionally include an output to a user of information relevant to the step, and may thus represent an improvement in the user interface over existing art by providing information (whether static or dynamically updated) that is not otherwise available.

Similarly, the logic of flow diagrams may be shown as sequential. However, similar logic could be parallel, massively parallel, object oriented, real-time, event-driven, cellular automaton, or otherwise, while accomplishing the same or similar functions. In order to perform the methods described herein, a processor may divide each of the steps described herein into a plurality of machine instructions, and may execute these instructions at the rate of several hundred, several thousand, several million, or several billion per second, in a single processor or across a plurality of processors. Such rapid execution may be necessary in order to execute the method in real time or near-real time as described herein. For example, in order to facilitate the unlocking of a vehicle door based on the location of a key fob, the system may need to calculate the range and AoA of the key fob multiple times per second.

The door may be unlocked for example by a signal to the door lock mechanism, generated by the UWB ranging system when the range between the vehicle and the peer device (e.g., a key fob or smartphone) is less than a predefined value.

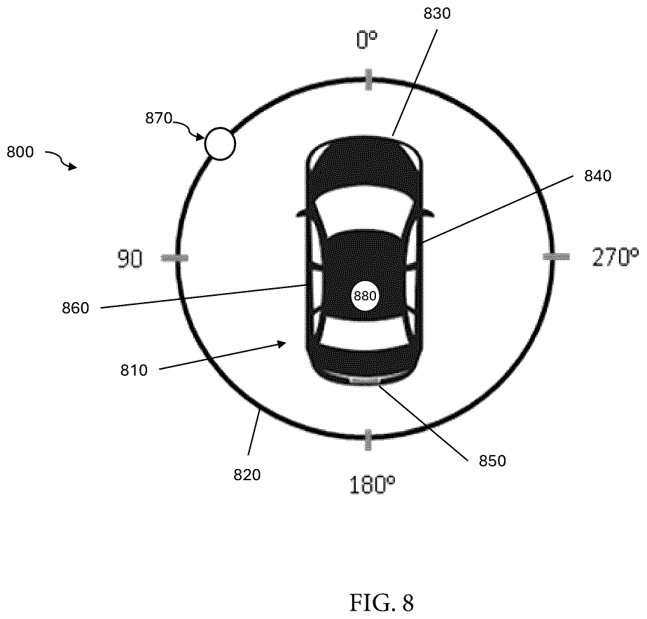

FIG. 8 illustrates a device localization system 800, in accordance with at least one embodiment of the present disclosure. As shown, the device system 800 includes a wireless communication device 870 and a single anchor 880 attached to a vehicle 810. Additionally, the angle positions around a vehicle 810 are illustrated. A direction indicator 820 shows that the front side 830 of the vehicle 810 is at 0 degrees, whereas the left side is at 90 degrees, the rear 850 is at 180 degrees, and the right 840 is at 270 degrees. These angles relate to those shown in FIGS. 4A-6 and 9-10. The wireless communication device 870 may generally include a UWB tag, and the anchor 880 may be any of the newly developed anchors described herein. The wireless communication device 870 may be in the form of a key fob or a smartphone with key fob functionality, as examples. Embodiments provided herein relate to localization of the wireless communication device 870 relative to the vehicle 810 (e.g., as determined using the anchor 880). The anchor 880 may be attached at any of a variety of locations on the vehicle, such as integrated into a shark fin antenna.

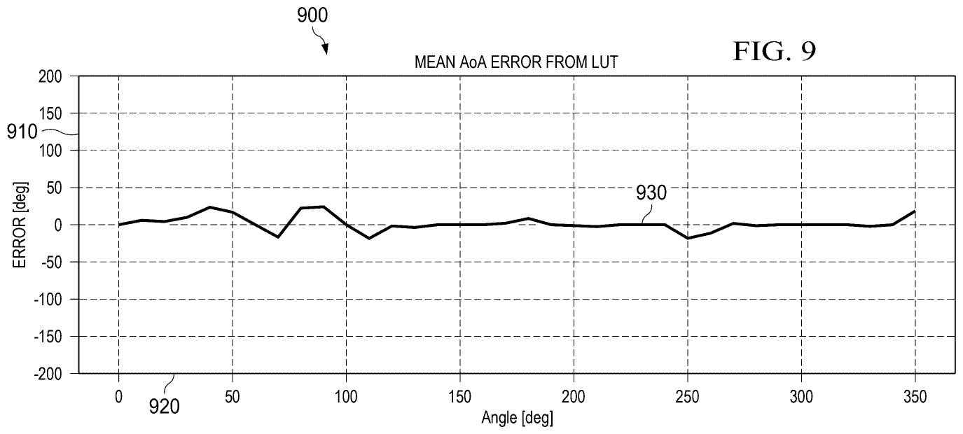

FIG. 9 is a plot 900 showing the mean angle of arrival (AoA) error 910 as a function of angle 920, in accordance with at least one embodiment of the present disclosure. The AoA error may for example be the difference between the AoA from the lookup table and the actual AoA of the signal from the peer device. The curve 930 shows that the AoA error ranges from between +30 to −20 degrees, but is close to zero (e.g., less than 10 degrees) at most angles 920. Such values for AoA error may be sufficient for keyless entry applications, where a vehicle door is unlocked based on the position of a UWB peer device such as a smartphone or key fob.

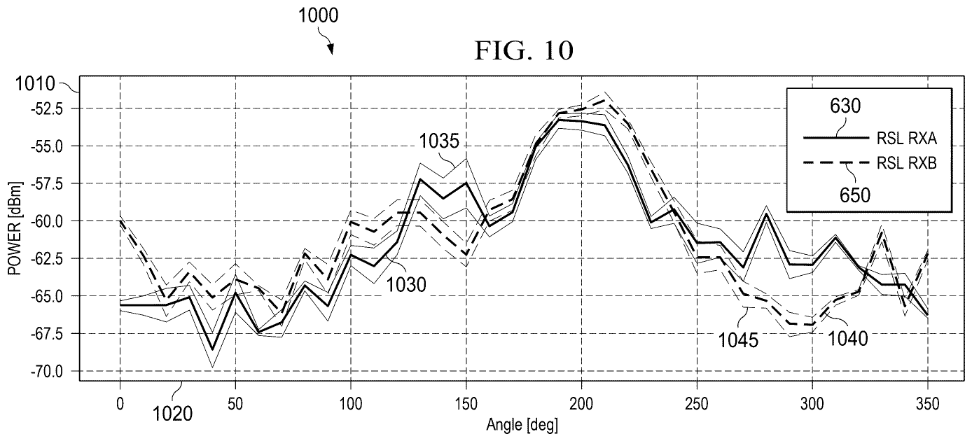

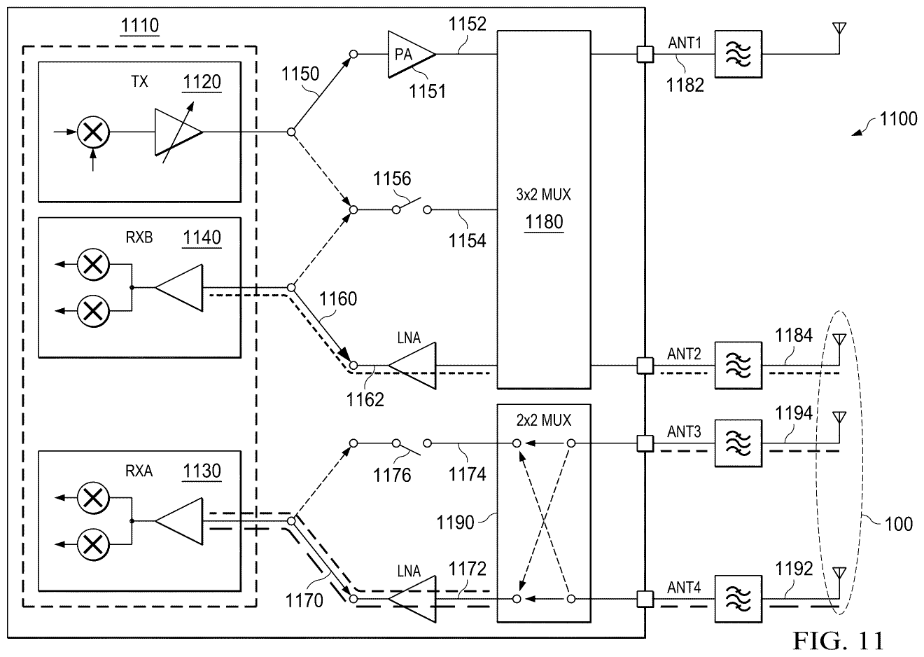

FIG. 10 is a plot 1000 showing link budget or received signal power level 1010 (e.g., in dB) as a function of angle 1020 (e.g., in degrees), at an antenna located 5 meters from the signal source, for each of two receivers 1030 and 1040, in accordance with at least one embodiment of the present disclosure. The link budget consistently exceeds −70 dBm (whereas −87 dBm is the sensitivity limit), ensuring that at least one of the three antennas always has sufficient power to perform ranging. With two simultaneous receiving chains across the three antennas, the wireless device 1100 (see FIG. 11, below) automatically selects the shortest timestamp to calculate the range. This approach enhances the accuracy and reliability of the ranging process by leveraging the strongest available signal.

This data helps identify potential issues with signal attenuation or fading, which are critical for maintaining robust wireless connectivity. The limit for good ranging performance is measured to be −87 dBM. Also visible are the standard deviations 1035, 1045 of the link budgets 1030, 1040, which remain below 1.5 dB throughout the curve 1000, indicating reliable performance.

FIG. 11 is a schematic, diagrammatic representation of a wireless device 1100 incorporating the single-anchor UWB antenna array 100, in accordance with at least one embodiment of the present disclosure. The wireless device 1100 includes a transmitter 1120 that transmits through a single transmit antenna path 1182, and two receivers 1130 and 1140 that receive through three receive antenna paths 1184, 1192, and 1194, corresponding to the three antenna elements of the single-anchor UWB antenna array 100.

The wireless device 1100 includes switches 1150 and 1156 to enable or disable the RF front-end amplifier 1151 and alternative signal path 1154. The wireless device 1100 also includes a switch 1160, which, in the closed position (as shown), connects antenna path 1184 to receiver 1140 via multiplexer 1180 and signal path 1162. The wireless device 1100 also includes switches 1170 and 1176, to enable receiver 1130 to switchably receive signals from antenna path 1194 via multiplexer 1190 and signal path 1174, or from antenna path 1192 via multiplexer 1190 and signal path 1172.

The single-anchor UWB antenna array 100 includes three antenna elements arranged in a triangle, with each pair spaced by approximately 0.45λ at the center frequency of the highest channel of operation (16.8 mm in this example for UWB channel 9). The PDoA is measured between each pair of antennas in this triangle. To do this in a single two way ranging (TWR) exchange using only the 2 available receivers 1140 and 1130, the wireless device 1100 needs to be configured to connect one of the receiving antennas to one receiver (RXB, 1140) and the other two antennas to the second receiver (RXA, 1130) as shown in the FIG. 11.

The three PDoAs are computed from the Ipatov preamble (IP) and scrambled timestamp sequence (STS) segments received by each receiver as follows:
PDoA pair 0: IP_M on RXB_ANT2-IP_S on RXA_ANT3
PDoA pair 1: STS0_M on RXB_ANT2-STS0_S on RXA_ANT4
PDoA pair 2: IP_S on RXA_ANT3-STS0_S on RXA_ANT4

PDoA pair 0 and 1 use dual receiver mode, where the Ipatov and STS segments are recorded by two receivers. PDoA pair 2 is calculated from segments from the same receiver where the antenna path is switched internally between ANT 3 (antenna path 1194) and ANT 4 (antenna path 1192) during the duration of the pulse.

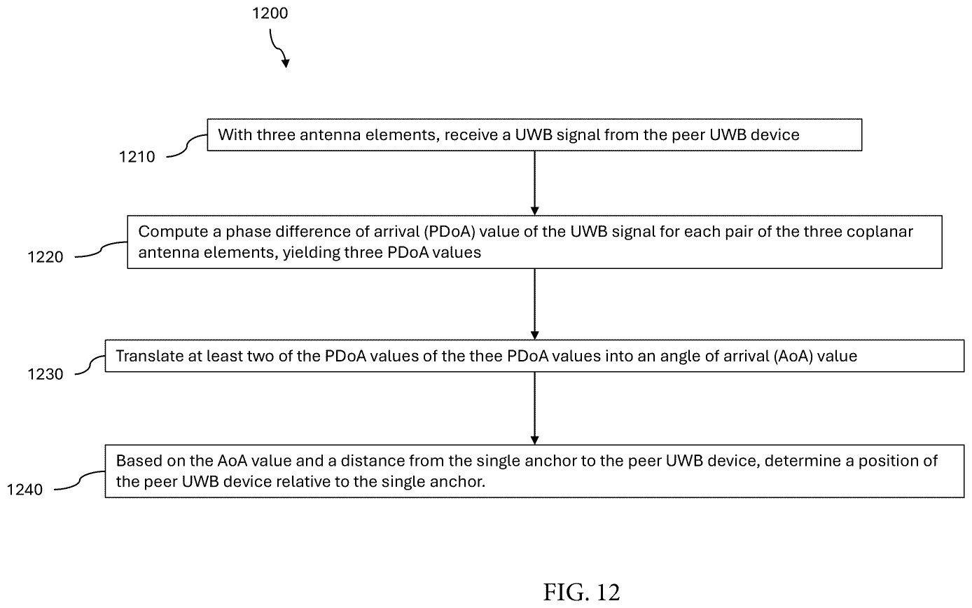

FIG. 12 is a schematic, diagrammatic representation, in flow diagram form, of an example method 1200 for localizing a peer UWB device relative to a vehicle, in accordance with at least one embodiment of the present disclosure.

The method 1200 employs an ultrawideband system comprising a single anchor disposed at a known location within the vehicle, and a processor disposed within the vehicle. The single anchor includes three antenna elements.

In step 1210, the method 1200 includes, with the three antenna elements, receiving a UWB signal from the peer UWB device, such as a key fob.

In step 1220, the method 1200 includes, with the processor, computing a phase difference of arrival (PDoA) value of the UWB signal for each pair of the three antenna elements, yielding three PDoA values. Execution then proceeds to step 1230.

In step 1230, the method 1200 includes, with the processor, translating at least two of the PDoA values of the three PDoA values into an angle of arrival (AoA) value. Execution then proceeds to step 1240.

In step 1240, the method 1200 includes, with the processor, based on the AoA value and a distance from the single anchor to the peer UWB device (e.g., computed using UWB two-way ranging), determining a position of the peer UWB device relative to the single anchor. In some embodiments, if the position of the of the peer UWB device (such as a key fob) is within a specified range or area (or any other criteria based on distance and/or AoA), a signal is produced (e.g., by the processor) to unlock one or more doors of the vehicle.

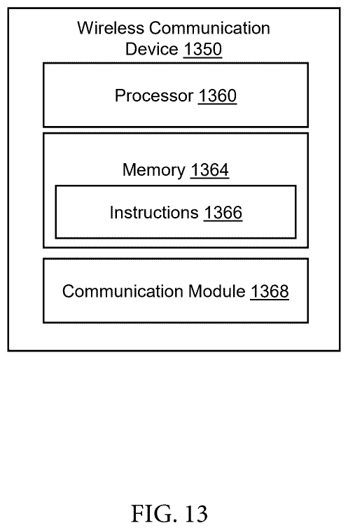

FIG. 13 is a schematic diagram of a wireless communication device 1350, in accordance with at least one embodiment of the present disclosure. As shown, the processor circuit 1350 may include a processor 1360, a memory 1364, and a communication module 1368. These elements may be in direct or indirect communication with each other, for example via one or more buses. In some embodiments, the wireless communication device 1350 may be or include an anchor that includes the wireless device 1100. For example, in some embodiments, the communication module 1368 may implement the wireless device 1100 as well as other well-known circuitry in the art for transmitting and/or receiving UWB signals using the wireless device, such as digital-to-analog and analog-to-digital converters and one or more baseband processors.

The processor 1360 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 1360 may also comprise another hardware device, a firmware device, or any combination thereof configured to perform the operations described herein. The processor 1360 may also be implemented as a combination of computing devices, e.g., a combination of a DSP and a microprocessor, a plurality of microprocessors, one or more microprocessors in conjunction with a DSP core, or any other such configuration.

The memory 1364 may include a cache memory (e.g., a cache memory of the processor 1360), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 1364 includes a non-transitory computer-readable medium. The memory 1364 may store instructions 1366. The instructions 1366 may include instructions that, when executed by the processor 1360, cause the processor 1360 to perform the operations described herein, such as one or more of the steps described with respect to FIG. 12, including storage of the LUTs described herein and/or computations to determine AoA and distance estimates. Instructions 1366 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 1368 can include any electronic circuitry and/or logic circuitry to facilitate direct or indirect communication of data between the processor circuit 1350, and other processors or devices. In that regard, the communication module 1368 can be an input/output (I/O) device. In some instances, the communication module 1368 facilitates direct or indirect communication between various elements of the processor circuit 1350 and/or the wireless device 1100. The communication module 1368 may communicate within the processor circuit 1350 through numerous methods or protocols. Serial communication protocols may include but are not limited to United States Serial Protocol Interface (US SPI), Inter-Integrated Circuit (I²C), Recommended Standard 232 (RS-232), RS-485, Controller Area Network (CAN), Ethernet, Aeronautical Radio, Incorporated 429 (ARINC 429), MODBUS, Military Standard 1553 (MIL-STD-1553), or any other suitable method or protocol. Parallel protocols include but are not limited to Industry Standard Architecture (ISA), Advanced Technology Attachment (ATA), Small Computer System Interface (SCSI), Peripheral Component Interconnect (PCI), Institute of Electrical and Electronics Engineers 488 (IEEE-488), IEEE-1284, and other suitable protocols. Where appropriate, serial and parallel communications may be bridged by a Universal Asynchronous Receiver Transmitter (UART), Universal Synchronous Receiver Transmitter (USART), or other appropriate subsystem.

As will be readily appreciated by those having ordinary skill in the art after becoming familiar with the teachings herein, the single-anchor UWB antenna array advantageously allows for ranging and positioning calculations between a vehicle UWB device and a peer device (e.g., a UWB-enabled key fob or smartphone) to be performed with a single anchor, instead of the multi-anchor (e.g., six-anchor) systems currently in use.

A number of variations are possible on the examples and embodiments described above. For example, the exact form of the crossed dipole antennas may be different than shown herein. For example, rather than being square, the crossed dipole antennas may be round, triangular, polygonal, or another shape. Similarly, while the example single-anchor UWB antenna arrays shown herein have the three antenna elements arranged in a co-planar isosceles triangle, a person of ordinary skill in the art would appreciate that other co-planar and slightly non-co-planar arrangements for the three elements may be used, including right triangles, equilateral triangles, etc., without departing from the spirit of the present invention. The design of the wireless device 1100 may be different than shown herein, while still making use of the single-anchor UWB antenna array disclosed herein, or a similar single-anchor UWB antenna array.

The technology described herein may be employed in remote access and keyless entry applications for buildings and vehicles of diverse types, and may also be used in other access control applications to control access to communication devices, computing devices, safes, vaults, cabinets, etc.

Accordingly, the logical operations making up the embodiments of the technology described herein are referred to variously as operations, steps, objects, elements, components, or modules. Furthermore, it should be understood that these may occur, or be performed or arranged, in any order, unless explicitly claimed otherwise or a specific order is inherently necessitated by the claim language.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the single-anchor UWB antenna array. Connection references, e.g., attached, coupled, connected, joined, or “in communication with” are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” The word “comprising” does not exclude other elements or steps, and the indefinite article “a” or “an” does not exclude a plurality. Unless otherwise noted in the claims, stated values shall be interpreted as illustrative only and shall not be taken to be limiting.

The above specification, examples and data provide a complete description of the structure and use of exemplary embodiments of the single-anchor UWB antenna array as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A method for localizing a peer ultrawideband (UWB) device relative to a vehicle, the vehicle comprising an anchor disposed within the vehicle, the anchor comprising three antenna elements, the method comprising:
with the three antenna elements, receiving a UWB signal from the peer UWB device;
computing a phase difference of arrival (PDoA) value of the UWB signal for each pair of the three antenna elements, yielding three PDoA values;
translating at least two of the PDoA values of the three PDoA values into an angle of arrival (AoA) value; and
based on the AoA value and a distance from the anchor to the peer UWB device, determining a position of the peer UWB device relative to the anchor.

2. The method of claim 1, further comprising computing the distance from the anchor to the peer UWB device based on two-way ranging between the anchor and the peer UWB device.

3. The method of claim 1, wherein the three antenna elements are coplanar and arranged in an isosceles triangle.

4. The method of claim 3, wherein each of the three antenna elements is an omnidirectional antenna element.

5. The method of claim 3, wherein each antenna element of the three coplanar antenna elements comprises:
a planar dielectric substrate;
a first crossed dipole antenna printed on a first side of the planar dielectric substrate; and
a second crossed dipole antenna printed on a second side the planar dielectric substrate.

6. The method of claim 1, wherein the anchor further comprises:
two multiplexers; and
two receivers configured to receive second UWB signals from the peer device via the three antenna elements and the two multiplexers.

7. The method of claim 1, wherein a position error of the anchor in measuring the position of the peer UWB device is between 0 centimeters and 10 centimeters at a range of 3 meters and between 0 centimeters and 15 centimeters at a range of 5 meters.

8. An ultrawideband (UWB) system for localizing a peer UWB device relative to a vehicle, the UWB system comprising:
an anchor disposed within the vehicle, the anchor comprising three antenna elements configured to receive a UWB signal from the peer UWB device; and
a processor configured to:
compute a phase difference of arrival (PDoA) value of the UWB signal for each pair of the three antenna elements, yielding three PDoA values;
translate at least two of the PDoA values of the three PDoA values into an angle of arrival (AoA) value; and
based on the AoA value and a distance from the anchor to the peer UWB device, determine a position of the peer UWB device relative to the anchor.

9. The system of claim 8, wherein the processor is further configured to use UWB two-way ranging between the anchor and the UWB peer device to compute the distance from the anchor to the peer UWB device.

10. The system of claim 8, wherein the three antenna elements are coplanar and arranged in an isosceles triangle.

11. The system of claim 10, wherein each of the three antenna elements is an omnidirectional antenna element.

12. The system of claim 10, wherein each antenna element of the three coplanar antenna elements comprises:
a planar dielectric substrate;
a first crossed dipole antenna printed on a first side of the planar dielectric substrate; and
a second crossed dipole antenna printed on a second side the planar dielectric substrate.

13. The system of claim 8, wherein the anchor further comprises:
two multiplexers; and
two receivers configured to receive second UWB signals from the peer device via the three antenna elements and the two multiplexers.

14. The system of claim 8, wherein a position error of the anchor in measuring the position of the peer UWB device is between 0 centimeters and 10 centimeters at a range of 3 meters and between 0 centimeters and 15 centimeters at a range of 5 meters.

15. A vehicle, comprising:
an ultrawideband (UWB) system for localizing a peer UWB device relative to the vehicle, the UWB system comprising:
an anchor disposed within the vehicle, the anchor comprising three antenna elements configured to receive a UWB signal from the peer UWB device; and
a processor configured to:
compute a phase difference of arrival (PDoA) value of the UWB signal for each pair of the three antenna elements, yielding three PDoA values;
translate at least two of the PDoA values of the three PDoA values into an angle of arrival (AoA) value; and
based on the AoA value and a distance from the anchor to the peer UWB device, determine a position of the peer UWB device relative to the anchor.

16. The vehicle of claim 15, wherein the processor is further configured to use UWB two-way ranging between the anchor and the UWB peer device to compute the distance from the anchor to the peer UWB device.

17. The vehicle of claim 15, wherein the three antenna elements are coplanar and arranged in an isosceles triangle.

18. The vehicle of claim 17, wherein each of the three antenna elements is an omnidirectional antenna element.

19. The vehicle of claim 17, wherein each antenna element of the three coplanar antenna elements comprises:
a planar dielectric substrate;
a first crossed dipole antenna printed on a first side of the planar dielectric substrate; and
a second crossed dipole antenna printed on a second side the planar dielectric substrate.

20. The vehicle of claim 15, wherein the anchor further comprises:
two multiplexers; and
two receivers configured to receive second UWB signals from the peer device via the three antenna elements and the two multiplexers.
